(19) United States
(12) Patent Application Publication
(10) Pub. No.: US 2009/0099696 A1
(43) Pub. Date: Apr. 16, 2009

(54) SYSTEM AND METHOD OF REPORTING AND MANAGING REAL-TIME AIRFLOW WITHIN AN INFORMATION HANDLING SYSTEM

(75) Inventors: Paul T. Artman, Austin, TX (US); Robert Riegler, Austin, TX (US)

Correspondence Address: LARSON NEWMAN ABEL & POLANSKY, LLP, 5914 WEST COURTYARD DRIVE, SUITE 200, AUSTIN, TX, 78730, US

(73) Assignee: DELL PRODUCTS, LP, Round Rock, TX (US)

(21) Appl. No.: 11/872,969

(22) Filed: Oct. 16, 2007

(51) Int. Cl. G05B 15/00

(52) U.S. Cl. 700/276; 454/239

(57) ABSTRACT

A system and method of reporting and managing real-time air flow within an information handling system is disclosed. In one form, a method of managing airflow can include obtaining airflow data using a range of fan speeds of a first cooling fan within a first information handling system. The method can also include storing the airflow data within a memory accessible to a management controller. The method can further include accessing the airflow data to identify a first airflow output level, and altering an operating speed of the first cooling fan to output the first airflow output level.

### FIELD OF THE DISCLOSURE

This disclosure relates generally to information handling systems, and more particularly to a system and method of reporting and managing real-time airflow within an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements can vary between different applications, information handling systems can also vary regarding what information is handled, how the information is handled, how much information is processed, stored, or communicated, and how quickly and efficiently the information can be processed, stored, or communicated. The variations in information handling systems allow for information handling systems to be general or configured for a specific user or specific use such as financial transaction processing, airline reservations, enterprise data storage, or global communications. In addition, information handling systems can include a variety of hardware and software components that can be configured to process, store, and communicate information and can include one or more computer systems, data storage systems, and networking systems.

Energy consumption of cooling infrastructures for some data centers is becoming more of a concern as information technology (IT) equipment consumes more power and equipment density increases. For example, some IT companies have complex power/airflow calculators that allow customers to determine the airflow consumed by their equipment and used to cool servers. Such calculators employ complex algorithms that use many real time variable inputs such as inlet temperature, system hardware configuration, and system stress.

For example, low fan speed operating points of some IT equipment and systems can be dictated by a minimum fan speed required to cool components that have minimal or no thermal feedback (i.e. voltage regulator components, dual input memory modules (DIMM's), hard drives, etc.) within the system at a given ambient temperature. In some instances, as the ambient temperature increases, fan speed increases as a function of the fan cooling capability along with the required cooling demand of that particular system. Additionally, fan speed ramp rate may change as function of hardware configuration or system stress load. As such, the fan speed ramp rate can be system dependant.

Because of the many variations that dictate system fan speed, many IT airflow calculators reflect worst-case numbers that often do not reflect customer site operating environments. As a result, some a limited number of systems may be deployed at a site, or an unnecessarily oversized cooling capacity may be used. Both of these consequences can result in either monetary or opportunity costs.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 illustrates a block diagram of an information handling system according to one aspect of the disclosure;

FIG. 2 illustrates a functional block diagram of an airflow management system according to another aspect of the disclosure; and

FIG. 3 illustrates a flow diagram of a method of managing airflow within an information handling system according to a one aspect of the disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be utilized in this application. The teachings can also be utilized in other applications and with several different types of architectures such as distributed computing architectures, client/server architectures, or middleware server architectures and associated components.

For purposes of this disclosure, an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system can be a personal computer, a PDA, a consumer electronic device, a wireless communication device, a diskless computer system, a thin client, a network server or storage device, a switch router, wireless router, or other network communication device, or any other suitable device and can vary in size, shape, performance, functionality, and price. The information handling system can include memory, one or more processing resources such as a central processing unit (CPU) or hardware or software control logic. Additional components of the information handling system can include one or more storage devices, one or more communications ports for communicating with external devices as well as various input and output (I/O) devices, such as a keyboard, a mouse, and a video display. The information handling system can also include one or more buses operable to transmit communications between the various hardware components.

According to one aspect of the disclosure, a method of managing airflow is disclosed. The method can include obtaining airflow data using a range of fan speeds of a first cooling fan within a first information handling system. The method can also include storing the airflow data within a memory accessible to a management controller. The method can further include accessing the airflow data to identify a first airflow output level, and altering an operating speed of the first cooling fan to output the first airflow output level.

According to another aspect of the disclosure, an airflow management system is disclosed. The airflow management system can include a first cooling fan operable to output an airflow to cool an information handling system. In one form, the first cooling fan can include a range of operating speeds operable to output a plurality of airflow output levels. The airflow management system can also include a management controller operably coupled to the first cooling fan and operable to alter operation of the first cooling fan to output the plurality of airflow output levels in response to an airflow consumption of the first information handling system. The airflow management system can further include a memory coupled to the management controller and configured to store a plurality of references to the plurality of operating speeds of the first cooling fan. In one form, the plurality of references can be configured to be accessed by the management controller to determine at least one of the plurality of airflow output levels.

According to a further aspect of the disclosure, an information handling system is disclosed. The information handling system can include a first cooling fan configured to operate across a first range of operating speeds, and a second cooling fan configured to operate across a second range of operating speeds. The information handling system can further include a memory configured to access a plurality of references identifying the first range of operating speeds and the second range of operating speeds. The information handling system can also include a management controller configured to detect an airflow consumption demand, identify an airflow output level to satisfy the airflow consumption demand, identify a first operating speed of the first cooling fan using the airflow output level, and identify a second operating speed of the second cooling fan using the airflow output level. The management controller can be further configured to initiate altering operation of the first cooling fan and the second cooling fan in response to the airflow output level.

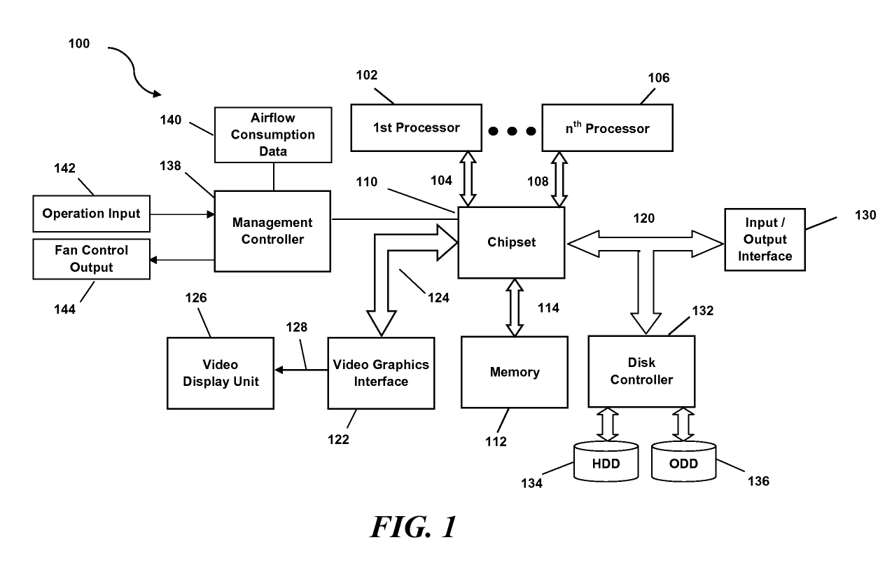

FIG. 1 illustrates a block diagram of an exemplary embodiment of an information handling system, generally designated at 100. In one form, the information handling system 100 can be a computer system such as a server. As shown in FIG. 1, the information handling system 100 can include a first physical processor 102 coupled to a first host bus 104 and can further include additional processors generally designated as n^{th} physical processor 106 coupled to a second host bus 108. The first physical processor 102 can be coupled to a chipset 110 via the first host bus 104. Further, the n^{th} physical processor 106 can be coupled to the chipset 110 via the second host bus 108. The chipset 110 can support multiple processors and can allow for simultaneous processing of multiple processors and support the exchange of information within information handling system 100 during multiple processing operations.

According to one aspect, the chipset 110 can be referred to as a memory hub or a memory controller. For example, the chipset 110 can include a dedicated bus to transfer data between first physical processor 102 and the n^{th} physical processor 106. For example, the chipset 110 including a chipset that can include a memory controller hub and an input/output (I/O) controller hub. As a memory controller hub, the chipset 110 can function to access the first physical processor 102 using first bus 104 and the n^{th} physical processor 106 using the second host bus 108. The chipset 110 can also be used as a memory interface for accessing memory 112 using a memory bus 114. In a particular embodiment, the buses 104, 108, and 114 can be individual buses or part of the same bus. The chipset 110 can also include bus control and can handle transfers between the buses 104, 108, and 114.

According to another aspect, the chipset 110 can include an application specific chipset that connects to various buses, and integrates other system functions. For example, the chipset 110 can include using an Intel® Hub Architecture (IHA) chipset that can also include two parts, a Graphics and AGP Memory Controller Hub (GMCH) and an I/O Controller Hub (ICH). For example, an Intel 820E, an 815E chipset, an Intel 975X chipset, an Intel G965 chipset, available from the Intel Corporation of Santa Clara, Calif., or any combination thereof, can be used as at least a portion of the chipset 110. The chipset 110 can also be packaged as an application specific integrated circuit (ASIC).

In one form, the chipset 110 can be coupled to a video graphics interface 122 using a third bus 124. In one form, the video graphics interface 122 can be a Peripheral Component Interconnect (PCI) Express interface operable to content to display within a video display unit 126. Other graphics interfaces may also be used. The video graphics interface 122 can output a video display output 128 to the video display unit 126. The video display unit 126 can include one or more types of video displays such as a flat panel display (FPD), cathode ray tube display (CRT) or other type of display device.

The information handling system 100 can also include an I/O interface 130 that can be connected via an I/O bus 120 to the chipset 110. The I/O interface 130 and I/O bus 120 can include industry standard buses or proprietary buses and respective interfaces or controllers. For example, the I/O bus 120 can also include a PCI bus or a high speed PCI-Express bus. In one embodiment, a PCI bus can be operated at approximately 66 MHz and a PCI-Express bus can be operated at more than one (1) speed (e.g. 2.5 GHz and 5 GHz). PCI buses and PCI-Express buses can comply with industry standards for connecting and communicating between various PCI-enabled hardware devices. Other buses can also be used in association with, or independent of, the I/O bus 120 including, but not limited to, industry standard buses or proprietary buses, such as Industry Standard Architecture (ISA), Small Computer Serial Interface (SCSI), Inter-Integrated Circuit (I²C), System Packet Interface (SPI), or Universal Serial buses (USBs).

In an alternate embodiment, the chipset 110 can be a chipset employing a Northbridge/Southbridge chipset configuration (not illustrated). For example, a Northbridge portion of the chipset 110 can communicate with the first physical processor 102 and can control interaction with the memory 112, the I/O bus 120 that can be operable as a PCI bus, and activities for the video graphics interface 122. The Northbridge portion can also communicate with the first physical processor 102 using first bus 104 and the second bus 108 coupled to the n^{th} physical processor 106. The chipset 110 can also include a Southbridge portion (not illustrated) of the chipset 110 and can handle I/O functions of the chipset 110. The Southbridge portion can manage the basic forms of I/O such as Universal Serial Bus (USB), serial I/O, audio outputs, Integrated Drive Electronics (IDE), and ISA I/O for the information handling system 100.

The information handling system 100 can further include a disk controller 132 coupled to the I/O bus 120, and connecting one or more internal disk drives such as a hard disk drive (HDD) 134 and an optical disk drive (ODD) 136 such as a Read/Write Compact Disk (R/W CD), a Read/Write Digital Video Disk (R/W DVD), a Read/Write mini-Digital Video Disk (R/W mini-DVD), or other type of optical disk drive.

The information handling system 100 can also include a management controller 138 coupled to the chipset 110 and an airflow consumption data resource 140 stored within a memory accessible to the management controller 138. The management controller 138 can also be coupled to an operation input 142 operable to couple inputs to the management controller in association with operating one or more fans coupled to the fan control output 144.

In one form, a system level airflow can be determined as function of the system fan speeds output by the fan control output 144. The operating input 142 can couple dynamic and static inputs to the management controller 138 to determine the system fan speeds. According to one aspect, system level airflow can be determined using a number of factors such as hardware configuration, component temperatures, external ambient temperature, etc, which can be generally represented by the operational input 142 into the management controller 138 to output the fan control output 144.

During operation, the management controller 138 can be used to manage airflow within the information handling system 100 to ensure an operating temperature can be maintained. In one form, the airflow consumption data 140 can be obtained in advance of outputting the fan control output 144 by varying the operating speed of one or more fans using the fan control output 144, and detecting an airflow consumption using the operation input 142. In one form, the management controller 138 can increase (or decrease) the fan speed of the one or more cooling fans and store the airflow consumption relative to the fan speed within the airflow consumption data 140. The resulting airflow data at each speed can be stored within the airflow consumption data resource 140 relative to the operating speed of the one or more cooling fans. For example, the airflow data can be stored within a memory or table and accessed by the management controller 138 to alter an airflow output.

In one form, the management controller 138 can access the airflow consumption data 140 to identify a fan control output 144 of one or more fans to output a desired airflow output value. In this manner, complex algorithms or detection schemes may not be needed to output a desired airflow relative to changes in airflow consumption demands of the information handling system 100.

In one form, airflow consumption of the information handling system 100 can be collected and input or stored within memory or firmware tables of the management controller 138. For example, a number of test cases to control the fan output control 144 can be used to receive operation input 142 results. The results can be populated within firmware tables as airflow consumption data 140. For example, data can be limited to the range of fan speeds and a representative airflow of the information handling system 100 within a ±10% range at standard temperature and atmosphere. The resulting system level airflow can be represented by a polynomial, or a look-up table, stored within the firmware tables as airflow consumption data 140. For example, an airflow output level can be calculated by the management controller 138 and stored in designated address of the firmware or look-up table. The system level airflow output can then be relayed to a customer via a direct address pull, OMSA (Open Manage Server Administrator), or another compatible interface. In this manner, a user can size a data center cooling capacity and optimize data center cooling schemes.

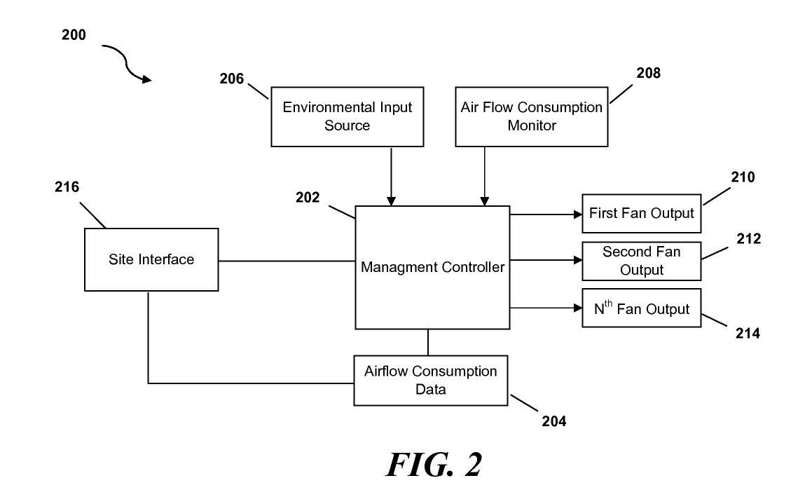

FIG. 2 illustrates a functional block diagram of an airflow management system, illustrated generally at 200, according to another aspect of the disclosure. The airflow management system 200 can be employed, in whole or in part, by the information handling system 100 illustrated in FIG. 1, or any other type of system than can be used to provide the airflow management system 200. The airflow management system 200 can include a management controller 202 operable to access airflow consumption data 204 stored within a memory, firmware, a look-up table, or various other types of storage devices operable to store airflow data. The management controller 202 can receive an input from an environmental input source 206, and an airflow consumption monitor 208. The management controller 202 can further be operable to output an output control signal to one or more cooling fans. For example, the management controller 202 can output a first fan output 210, a second fan output 212, an n^{th} fan output 214, or any combination thereof. In one form, the airflow management system 200 can be used to manage airflow within a single information handling system, or any number of information handling systems and can be scaled as needed or desired. For example, the airflow management system 200 can be used in association with one or more servers, server racks and enclosures, chassis components, fans, vents, and various other sources, or any combination thereof.

In another form, the management controller 202 can be accessed externally using a site interface 216 or other interface operable to enable access to the airflow management system 200. For example, the site interface 216 can include a site management interface, a data center integration source, or any other type of source or application that can access the airflow management system 200 or management controller 202. In one form the airflow management system 200 can be used in association with various third party modeling applications, including, but not limited to, applications provided by Flovent, Tilevent, Airpak, or others. In one form, the site interface 216 can be used to provide an end user airflow output of an information handling system during operation. An end user can access airflow requirements allowing a site manager to scale a data center or site accordingly. According to one aspect, low airflow conditions can be identified allowing to targeted increased low airflow and power efficiencies to reduce overall consumption of resources.

During operation, the environmental input source can 206 can input static or dynamic operating conditions of one or more information handling systems. For example, operating conditions such as humidity, elevation, density, or any combination thereof can be used. Such inputs, when combined with the airflow consumption monitor 208 input can be used to determine identify an airflow output of one or more fans coupled to the management controller 202. For example, the management controller 202 can determine an airflow output using the environmental input source 206 input and the airflow consumption monitor 208 input. The management controller 202 can access the airflow consumption data 204 that includes a look-up table identifying an airflow output value that can be output using one or more fans coupled to the management controller 202. In this manner, one or more fan outputs can be altered using airflow consumption data 204 and an associated look-up table with fan output capacities that can be identified relative to a desired airflow output of an information handling system coupling the environmental and current airflow consumption inputs to the management controller 202.

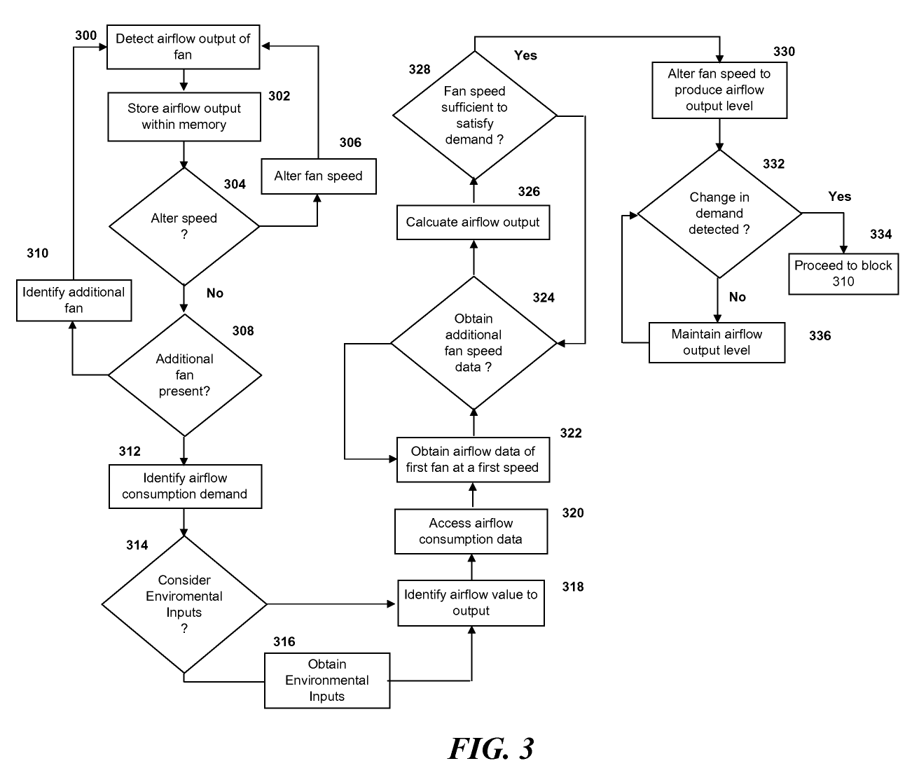

FIG. 3 illustrates a flow diagram of a method of managing airflow within an information handling system according to a one aspect of the disclosure. FIG. 3 can be employed in whole, or in part, by the information handling system 100 depicted in FIG. 1, the airflow management system 200 described in FIG. 2, or any other type of system, controller, device, module, processor, or any combination thereof, operable to employ all, or portions of, the method of FIG. 3. Additionally, the method can be embodied in various types of encoded logic including software, firmware, hardware, or other forms of digital storage mediums, computer readable mediums, or logic, or any combination thereof, operable to provide all, or portions, of the method of FIG. 3.

The method begins generally at block 300 as an airflow output of a fan can be detected. For example, a first fan can be operated at a first fan speed and the airflow output associated with the first fan speed can be detected. Upon detecting the airflow output associated with the first fan, the method can proceed to block 302, and the airflow output data can be stored with a memory. For example, an airflow output for a 1 U server enclosure unit can range between 10 and 100 cfm, and the airflow output data can represent a current airflow within that range. Other ranges of airflow, and size and number of units, can also be used. In one form, the airflow output data can be stored within a firmware device accessible to a management controller and in one form can be stored within a look up-table that can be accessed by a management controller of other device or application that can be used to access the airflow value. Upon storing the airflow output data, the method can proceed to decision block 304 and can determine if the fan speed of the fan should be altered. For example, the fan speed can be increased (or decreased) to another operating speed. As such, the method can proceed to block 306 and the fan speed can be altered, and to block 300 and repeats at the new fan speed.

If at decision block 304, the fan speed should not be altered, the method can proceed to decision block 308 and determines if an additional fan may be present. For example, an information handling system can include multiple fans that can be operated to output multiple airflow values. As such, if an additional fan can be used, the method can proceed to block 310, and an additional fan can be identified. The method can then proceed to block 300 and repeats.

If at decision block 308, no additional fans should be altered, the method can proceed to block 312, and an airflow consumption demand can be identified. For example, a specific fan or number of fans can be used to cool one or more regions of an information handling system at a specific airflow consumption demand. As such, upon identifying an airflow consumption demand, the method can proceed to decision block 314, and determines if one or more environmental inputs of the information handling system should be considered in association with the airflow consumption demand. For example, an environmental condition can include a humidity value, an operating temperature, altitude, density, or any combination thereof. If environmental inputs should be considered, the method can proceed to block 316 and environmental input values can be identified. For example, a management controller can be coupled to one or more sensors operable to detect an environmental operating condition of an information handling system.

If environmental inputs should not be considered, the method can then proceed to block 318 and an airflow output value to output can be identified. For example, if a change in airflow demand is detected, a complementary airflow output value can be determined to be output. In another form, as a consumption demand decreases, a complementary airflow output value to decrease the airflow output can be identified.

Upon identifying the airflow value to output, the method can proceed to block 318 and can access airflow consumption data 318 stored within memory, and to block 320 to obtain airflow data of a first fan operating at a first fan speed. For example, a first cooling fan can be operated at 75% of it available speed to output an airflow output value. As such, the method can access airflow data of the first fan.

Upon obtaining the airflow data of the first fan, the method can proceed to decision block 324, and determines if additional fan speed data should be obtained. For example, if an airflow output value of the first fan is not sufficient to generate an output relative to the demand, the method can proceed to block 322 and repeats. If at decision block 324 the fan speed data may be sufficient to satisfy the demand, or a portion of the demand (e.g. fan speed is maximum), the method can proceed to block 326 and can calculate a resulting airflow output using the operating speed obtained. The method can then proceed to decision block 328, and determines if the fan speed may be sufficient to satisfy the airflow demand. In one form at decision block 328 the fan speed can be sufficient to satisfy the demand, and the method can proceed to block 330 as described below. If at decision block 328, the fan speed may not be sufficient, the method can proceed to decision block 324 and repeats.

If at decision block 328, the fan speed may be sufficient to satisfy the demand, the method can proceed to block 330, and the fan speed of one or more of the cooling fans can be altered to output the desired airflow output level. The method can then proceed to decision block 332, and detects if a change in airflow consumption demand is detected. If at decision block 330, a change in demand may be detected, the method can proceed to block 334, and repeats at block 310. If at decision block 332, a change in demand may not be detected, the method can proceed to block 336, and the airflow output level can be maintained. The method can then proceed to block 332 and repeats.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A method of managing airflow comprising:
obtaining airflow data using a range of fan speeds of a first cooling fan within a first information handling system;
storing the airflow data within a memory accessible to a management controller;
accessing the airflow data to identify a first airflow output level; and
altering an operating speed of the first cooling fan to output the first airflow output level.

2. The method of claim 1, further comprising:
calculating the first airflow output level using the airflow data; and
outputting a first fan control signal to alter the operating speed of the first cooling fan.

3. The method of claim 1, further comprising:
inputting the airflow data into a firmware table accessible by the management controller;
accessing the firmware table using the management controller; and
identifying the first airflow output level using the accessed airflow consumption table.

4. The method of claim 3, further comprising
storing the airflow data within a look-up table of the firmware table;
accessing the look-up table to obtain the airflow data; and
outputting the first airflow output value identified within the look-up table to alter the operating speed of the first cooling fan.

5. The method of claim 1, further comprising:
detecting an environmental operating condition of the information handling system;
detecting whether to alter the first airflow output value in response to the environmental operating condition;
identifying a second airflow output value using the environmental operating condition and the airflow data; and
outputting the second airflow output value to the first cooling fan to alter the fan speed of the first cooling fan to output the second airflow output value.

6. The method of claim 1, further comprising:
obtaining a first airflow consumption value in response to altering the operating speed of the first cooling fan;
determining whether the first airflow consumption value is sufficient to cool the first information handling system; and
increasing the operation of the first cooling fan using the airflow data if the first airflow consumption value is not sufficient.

7. The method of claim 1, further comprising:
accessing the airflow data using an Open Manage Server Administrator (OMSA) interface; and
calculating the first airflow output value using the data accessed using the OMSA interface.

8. The method of claim 1, further comprising:
storing a plurality of operating ranges of a plurality of cooling fans;
storing a plurality of airflow data of the plurality of fans;
using the plurality of airflow data to determine a data center cooling scheme;
identifying an available data center cooling capacity of the data center using the plurality of airflow data; and
modifying the data center cooling scheme in response to the available data center cooling capacity.

9. The method of claim 1, further comprising:
obtaining a first airflow consumption value in response to altering the operating speed of the first cooling fan;
altering operation of the first cooling fan to a second fan speed;
obtaining a second airflow consumption value in response to the second fan speed; and
storing the first airflow consumption value and the second airflow consumption value within the memory.

10. The method of claim 9, further comprising:
accessing the memory to identify a desired operating speed of the first cooling fan;
identifying whether to use the first airflow consumption value or the second airflow consumption value; and
altering the operating speed of the first cooling fan using the first airflow consumption value or the second airflow consumption value.

11. The method of claim 10, further comprising:
accessing a lookup table within the memory to identify a first operating speed of the first cooling fan using the first airflow consumption value;
accessing the lookup table to identify a second operating speed of the first cooling fan using the second airflow consumption value;
altering the operating speed of the first cooling fan using the first operating speed or the second operating speed.

12. An airflow management system comprising:
a first cooling fan operable to output an airflow to cool an information handling system, wherein the first cooling fan includes a range of operating speeds operable to output a plurality of airflow output levels;
a management controller operably coupled to the first cooling fan and operable to alter operation of the first cooling fan to output the plurality of airflow output levels in response to an airflow consumption of the first information handling system; and
a memory coupled to the management controller and configured to store the a plurality of references to the plurality of operating speeds of the first cooling fan, the plurality of references configured to be accessed by the management controller to determine at least one of the plurality of the airflow output levels.

13. The airflow management system of claim 12, wherein the management controller is configured to accesses the plurality of references using a firmware interface.

14. The airflow management system of claim 13, further comprising:
wherein the management controller is further configured to receive an input identifying an environmental operating condition of the information handling system;
wherein the management controller is further operable to calculate an operating speed of the first cooling fan using the environmental operating condition and the airflow capacity of the first cooling fan; and
wherein the first cooling fan is responsive the management controller to output the airflow output using the calculated operating speed.

15. The airflow management system of claim 12, further comprising:
wherein the memory is further configured to be updated to store additional references to a plurality of fans operably associated with a data center;
an site management interface operable to access the additional references to determine an airflow capacity; and
wherein the site management interface is operable to enable altering operation of the plurality of fans to produce an airflow output level.

16. The airflow management system of claim 9, further comprising:
wherein the site management interface can be used to determine the effects of modifying a site configuration; and
wherein the operation of the plurality of cooling fans can be modified in response to the modification of the site configuration.

17. An information handling system comprising:
a first cooling fan configured to operate across a first range of operating speeds;
a second cooling fan configured to operate across a second range of operating speeds;
a memory configured to access a plurality of references identifying the first range of operating speeds and the second range of operating speeds; and
a management controller configured to:
detect an airflow consumption demand;
identify an airflow output level to satisfy the airflow consumption demand;
identify a first operating speed of the first cooling fan using the airflow output level;
identify a second operating speed of the second cooling fan using the airflow output level;
initiate altering operation of the first cooling fan and the second cooling fan in response to the airflow output level.

18. The information handling system of claim 17, wherein the management controller is further configured to:
receive an environmental operating condition input;
identify a modified airflow output level using the environmental operating condition and the plurality of references within the memory; and
initiate altering operation of the first cooling fan and the second cooling fan in response to the modified airflow output level.

19. The information handling system of claim 18, further comprising:
monitor the airflow consumption demand;
detect a decrease in the airflow consumption demand;
identify a lower airflow output level;
identify a first operating speed of the first cooling fan using the lower airflow output level;
identify a second operating speed of the second cooling fan using the lower airflow output level; and
initiate altering operation of the first cooling fan and the second cooling fan in response to the lower airflow output level.

20. The information handling system of claim 18, further comprising:
monitor the airflow consumption demand;
detect an increase in the airflow consumption demand;
identify a higher airflow output level;
identify a first operating speed of the first cooling fan using the higher airflow output level;
identify a second operating speed of the second cooling fan using the higher airflow output level; and
initiate altering operation of the first cooling fan and the second cooling fan in response to the higher airflow output level.
